(19) United States
(12) Patent Application Publication
(10) Pub. No.: US 2006/0067518 A1
(43) Pub. Date: Mar. 30, 2006

(54) Communication terminal with bandwidth widening expansion and echo compensation

(76) Inventors: Stefano Ambrosius Klinke, Kerpen (DE); Frank Lorenz, Bocholt (DE)

Correspondence Address: BELL, BOYD & LLOYD, LLC, P. O. BOX 1135, CHICAGO, IL, 60690-1135, US

(21) Appl. No.: 10/527,763

(22) PCT Filed: Aug. 20, 2003
(86) PCT No.: PCT/EP03/09234

§ 371 Date: Mar. 11, 2005

(30) Foreign Application Priority Data
Sep. 12, 2002 (EP) 02020601.7

(51) Int. Cl. H04M 9/08

(52) U.S. Cl. 379/406.01

(57) ABSTRACT

A communication terminal is provided having a signal reception path which has a bandwidth widening device for artificially widening the bandwidth of a received signal in the communication terminal, a digital/analog converter and a loudspeaker, and includes a signal transmission path, which has a microphone, a transmission path low-pass filter and an analog/digital converter, in which case an echo compensation device is provided between one output of the bandwidth widening device and a connecting point of the signal transmission path, beyond the analog/digital converter with respect to the microphone, and further provides a method for artificially widening the bandwidth of a received signal in a communication terminal.

### BACKGROUND OF THE INVENTION

It is known from the prior art for a communication terminal having a signal reception path, which has a bandwidth widening device for artificially widening the bandwidth of a received signal in the communication terminal, to have a digital/analog converter and a loudspeaker, and for such a communication terminal having a signal transmission path to have a microphone, a transmission path low-pass filter and an analog/digital converter. However, no such communication terminal has yet been introduced to the market.

The intended bandwidth widening device is directed toward widening the bandwidth of a narrowband received signal; to be precise, by sampling and evaluation of the received signal via a suitable algorithm. For example, the received signal may be in a frequency band between 300 and 3,400 Hz, so that the bandwidth can be widened both in the direction of low frequencies and in the direction of high frequencies.

Frequency analysis of the narrowband received signal leads, for example, to fundamentals being added on the low-frequency side of the narrowband received signal, whose harmonics are contained in the narrowband received signal. In a similar way, the narrowband received signal may contain fundamentals whose harmonics can be added to the high-frequency side of the narrowband received signal. Overall, this results in an improved tonal impression of a sound signal which is emitted via the loudspeaker and is based on the received signal whose bandwidth has been widened. In particular, this improves the subjectively perceived quality of the sound signal, which is predominantly a speech signal.

So-called echo compensation devices likewise are known from the prior art, which seek to suppress the sound signals, which are emitted via the loudspeaker, from the signal reception path on the signal transmission path. This is necessary in order to take account of the fact that the sound signals which are emitted from the loudspeaker are emitted once again via the microphone of the communication terminal and via an antenna of the communication terminal. As such, a call partner of a user of the communication terminal perceives his/her own speech signals as an echo.

The algorithms which are used for echo compensation have the characteristic that they cannot compensate for non-linear distortion of received signals. However, such non-linear distortion results from the bandwidth widening of the received signal as described above.

Against this background, the present invention is directed toward providing a communication terminal having a bandwidth widening device, in which echoes that occur can be effectively compensated for. A further aim is to specify a method for artificially widening the bandwidth of a received signal in a communication terminal, in which measures are taken for echo compensation.

### SUMMARY OF THE INVENTION

With regard to such communication terminal, the present invention offers a communication terminal having a signal reception path, which has a bandwidth widening device for artificially widening the bandwidth of a received signal in the communication terminal, a digital/analog converter and a loudspeaker, and includes a signal transmission path, which has a microphone, a transmission path low-pass filter and an analog/digital converter, in which case an echo compensation device is provided between one output of the bandwidth widening device and a connecting point of the signal transmission path, beyond the analog/digital converter with respect to the microphone.

The present invention thus provides for the output signal from the bandwidth widening device to be made available to the echo compensation device, such that the latter can use the algorithm associated with it to subtract the widened received signal from a signal on the signal transmission path.

It must be noted that the non-linear distortion in the received signal resulting from the bandwidth widening is contained in the input signal for the echo compensation device as signal components, so that the echo compensation device can be used in the known manner.

In one embodiment of the present invention, the bandwidth widening device operates at a first sampling rate, and the echo compensation device operates at a second sampling rate. A sampling rate conversion device is provided for conversion of an output signal from the bandwidth widening device at the first sampling rate to the second sampling rate, and the output of the sampling rate conversion device is connected to an input of the echo compensation device.

This procedure takes account of the fact that the bandwidth widening device and the echo compensation device may operate using different sampling rates, although the echo compensation device should retain an input signal whose sample rate corresponds to that sampling rate which is used by the echo compensation device. In many cases, the sampling rate of the bandwidth widening device is higher than that of the echo compensation device, so that the sampling rate conversion device has to reduce the sampling rate.

The sampling rate conversion device may interact with a conversion low-pass filter which has a pass characteristic which is matched to the second sampling rate for the echo compensation device. This embodiment relates to situations in which the first sampling rate is higher than the second sampling rate. In this case, it is important to avoid the input signal for the echo compensation device containing signal components whose frequency cannot be represented on the basis of the second sampling rate. The conversion low-pass filter is used for this purpose.

The first sampling rate for the bandwidth widening may be 16 kHz, and the second sampling rate for the echo compensation device may be 8 kHz. These values are typical values for a bandwidth widening device and for an echo compensation device, respectively, but they previously have not been combined with one another in the prior art.

In order to optimize the quality of the echo compensation, the pass characteristic of the conversion low-pass filter may be designed to pass signal components whose frequency is at least as high as that of the transmission path low-pass filter. If not, the conversion low-pass filter would suppress signal components which then could not be compensated for by the echo compensation device.

With regard to the inventive method, this is achieved by a method for artificially widening the bandwidth of a received signal in a communication terminal having a signal reception path and a signal transmission path, having the following successive steps:
a) sampling of the received signal in the signal reception path;
b) widening of the bandwidth of the received signal via a bandwidth widening algorithm on the basis of sample values obtained in step a), in order to obtain a widened received signal; and
c) compensation for the echo on the widened received signal for the signal transmission path via an echo compensation algorithm, with the widened received signal being sampled.

The individual method steps have already been explained above with reference to the description of the communication terminal with a bandwidth widening device and an echo compensation device.

It should be noted that the communication terminal with a bandwidth widening device and an echo compensation device can, in principle, operate with any combination of a first sampling rate and second sampling rate. In practice, the most frequent situation will be that in which the first sampling rate is higher than the second sampling rate; for example, twice the second sampling rate. An important factor for the present invention is, however, that the sampling rate of the output signal from the bandwidth widening device is matched to the sampling rate of the echo compensation device, in which it is also possible to increase the sampling rate for the output signal from the bandwidth widening device; for example, by interpolation.

Additional features and advantages of the present invention are described in, and will be apparent from, the following Detailed Description of the Invention and the Figures.

### BRIEF DESCRIPTION OF THE FIGURES

FIG. 1 shows a diagram to illustrate a frequency spectrum of a received signal whose bandwidth has been widened for a communication terminal according to the present invention.

FIG. 2 shows an overview block diagram of a circuit part of the communication terminal, in order to illustrate bandwidth widening and echo compensation.

### DETAILED DESCRIPTION OF THE INVENTION

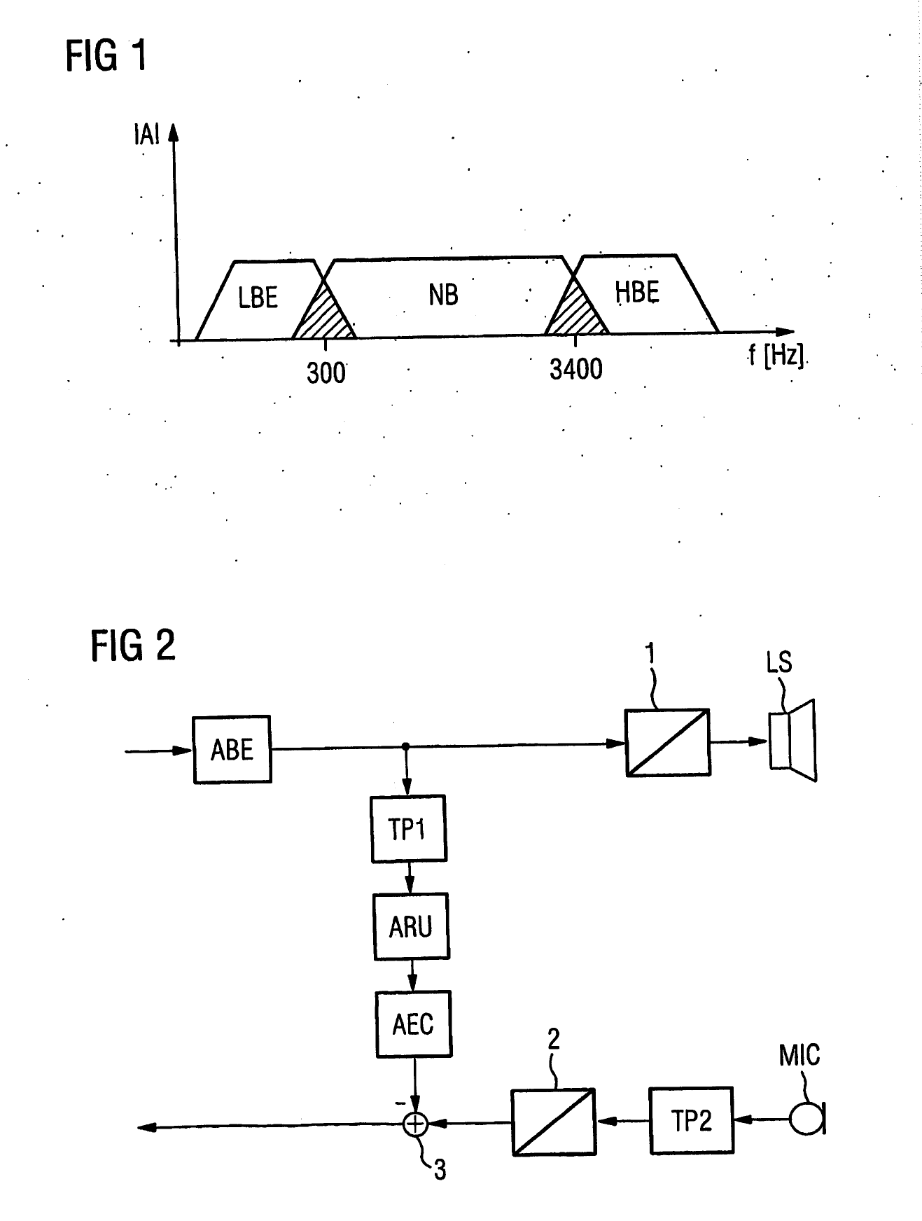

FIG. 1 shows the magnitude of the amplitude of signal components of a widened received signal as a function of the frequency. A central signal component NB originates from the received signal which has reached a communication terminal. In the present exemplary embodiment, the frequency range of the received signal extends from about 300 Hz to about 3,400 Hz, although the signal amplitude does not fall away suddenly but over a specific interval both at the high-frequency end and at the low-frequency end of the received signal.

A bandwidth widening device ABE (see FIG. 2), which is provided in a signal reception path in the communication terminal, ensures that the original bandwidth of the received signal is widened; to be precise, both at the high-frequency end and at the low-frequency end. Signal components HBE which are added at the high-frequency end overlap the central signal component NB of the original received signal. In this way, both signal components which originate from the original received signal and signal components which have been generated by the bandwidth widening device ABE occur and overlap in a frequency band of around 3,400 Hz. Such overlapping should be regarded as desirable since this is used to optimize the acoustic characteristics of a widened received signal. The same also applies to the low-frequency end of the original received signal; that is to say, the central signal component NB. Signal components LBE are added at its low-frequency end, with the signal components LBE and the central signal components NB overlapping in the band around 300 Hz.

The added signal components LBE, HBE take care of non-linear distortion in the stated overlapping areas, whose effects in terms of echoes cannot be suppressed by simple filtering. The overlapping areas that have been mentioned are shown by dashed lines for illustration purposes in FIG. 1.

The design of a circuit part of the communication terminal as illustrated in FIG. 2 has a signal reception path and a signal transmission path. The signal reception path is characterized by a bandwidth widening device ABE, to whose input the original 8 kHz received signal, which has reached the communication terminal, is applied. Bandwidth widening is carried out via a suitable algorithm for bandwidth widening using a sampling rate of 16 KHz, which results in the output signal from the bandwidth widening device ABE having a frequency spectrum which is comparable to that shown in FIG. 1.

The output signal from the bandwidth widening device ABE, which is at a sampling rate of 16 kHz, is supplied to a digital/analog converter 1, whose output signal is converted via a loudspeaker LS to a sound signal.

The sound signal that is emitted from the loudspeaker and is provided for a user of the communication terminal is also passed into a microphone MIC in the communication terminal which, in principle, is used for recording speech signals, which are returned to the user of the communication terminal. In this way, the sound signal which is emitted from the loudspeaker LS occurs as an echo in the sound signal recorded by the microphone MIC.

The microphone MIC forms a first element of the signal transmission path. Its output signal is supplied to a transmission path low-pass filter TP2, whose flank is matched to a sampling rate of a downstream analog/digital converter 2. In the present exemplary embodiment, the analog/digital converter 2 operates at a sampling rate of 8 kHz, so that the transmission path low-pass filter TP2 should attenuate signal frequencies above 4 kHz in order to satisfy the Nyquist condition that is appropriate here.

The output signal from the analog/digital converter 2 now contains both signal components which result from speech signals produced by the user of the communication terminal and signal components in the form of echoes which originate from the loudspeaker LS.

The components of the illustrated circuit that will be described now are of particular importance for suppression of echoes. The output signal from the bandwidth widening device ABE, which is at a first sampling rate of 16 kHz, is supplied to a conversion low-pass filter TP1 in the form of a decimation low-pass filter. The output signal from the conversion low-pass filter TP1 is passed to a sampling rate conversion device ARU, which converts the first sampling rate of 16 kHz to a second sampling rate of 8 kHz. In this case, the conversion low-pass filter TP1 ensures adequate attenuation of signal components at a frequency of more than 4 kHz applied to its input. In principle, the conversion low-pass filter should not attenuate signal components at a frequency which is also passed by the transmission path low-pass filter TP2. This ensures that echoes which are passed through the transmission path low-pass filter TP2 also may be compensated for by an echo compensation device AEC, which will now be described.

The echo compensation device AEC uses a suitable algorithm for compensation for echoes in the output signal from the analog/digital converter 2, and operates at a second sampling rate of 8 kHz. The output signal from the echo compensation device AEC is applied to a connecting point 3 in the signal transmission path, which is also connected to an output of the analog/digital converter 2. Echo compensation is carried out at the connecting point 3; to be precise, with the aid of a compensation signal which is generated by the echo compensation device AEC via the echo compensation algorithm. The sampling rate of the communication signal corresponds to the sampling rate of the output signal from the analog/digital converter 2.

Although the present invention has been described with reference to specific embodiments, those of skill in the art will recognize that changes may be made thereto without departing from the spirit and scope of the present invention as set forth in the hereafter appended claims.

1-7. (canceled)

8. A communication terminal, comprising:
a signal reception path which includes a bandwidth widening device for artificially widening a bandwidth of a received signal in the communication terminal, a digital/analog converter and a loudspeaker; and
a signal transmission path which includes a microphone, a transmission path low-pass filter and an analog/digital converter;
wherein an echo compensation device is provided between one output of the bandwidth widening device and a connecting point of the signal transmission path, beyond the analog/digital converter with respect to the microphone.

9. A communication terminal as claimed in claim 8, wherein the bandwidth widening device operates at a first sampling rate, the echo compensation device operates at a second sampling rate which is different from the first sampling rate, and a sampling rate conversion device is provided for conversion of an output signal from the bandwidth widening device at the first sampling rate to the second sampling rate, and an output of the sampling rate conversion device is connected to an input of the echo compensation device.

10. A communication terminal as claimed in claim 9, wherein the sampling rate conversion device interacts with a conversion low-pass filter having a pass characteristic which is matched to the second sampling rate for the echo compensation device, with the first sampling rate being higher than the second sampling rate.

11. A communication terminal as claimed in claim 9, wherein the first sampling rate for the bandwidth widening device is 16 kHz, and the second sampling rate for the echo compensation device is 8 kHz.

12. A communication terminal as claimed in claim 10, wherein the pass characteristic of the conversion low-pass filter for passing signal components is at least as high as a frequency of the transmission path low-pass filter.

13. A method for artificially widening a bandwidth of a received signal in a communication terminal having a signal reception path and a signal transmission path, the method comprising:
sampling the received signal in the signal reception path;
widening the bandwidth of the received signal via a bandwidth widening algorithm based on sample values obtained in the step of sampling so as to obtain a widened received signal; and
compensating for an echo on the widened received signal for the signal transmission path via an echo compensation algorithm, with the widened received signal being sampled.

14. A method for artificially widening a bandwidth of a received signal in a communication terminal as claimed in claim 13, wherein the step of widening is carried out at a first sampling frequency, the sampling in the step of compensating is carried out at a second sampling frequency, which is different from the first sampling frequency, and a widened received signal obtained in the step of widening is converted to the second sampling frequency before the step of compensating is carried out.
